(19) United States
(12) Patent Application Publication
(10) Pub. No.: US 2016/0284007 A1
(43) Pub. Date: Sep. 29, 2016

(54) INFORMATION PROCESSING APPARATUS, INFORMATION PROCESSING METHOD, AND RECORDING MEDIUM

(71) Applicant: NEC Corporation, Tokyo (JP)

(72) Inventor: ATSUNORI SAKAI, Tokyo (JP)

(73) Assignee: NEC Corporation

(21) Appl. No.: 15/068,813

(22) Filed: Mar. 14, 2016

(30) Foreign Application Priority Data
Mar. 25, 2015 (JP) 2015-062055

(51) Int. Cl. G06Q 30/06; G06F 17/30; G06N 99/00

(52) U.S. Cl. CPC G06Q 30/0631; G06N 99/005; G06F 17/3053

(57) ABSTRACT

Disclosed is that an information processing apparatus comprising: a memory storing instructions; and at least one processor configured to process the instructions to: perform pre-processing of transforming product data including a product image and a product description into a feature value; perform, as learning, machine learning on a feature value of user data indicating an attribute of a user purchasing a product and the feature value of the product data, and creating a model that learned a correlation between the feature value of the user data and the feature value of the product data; and acquire the feature data of the user data corresponding to a user accessing a site where products are being sold and the feature values of the product data of the products, calculate relevance scores by performing machine learning to which the model is applied, and determine a recommendation ranking of the products based on the relevance scores.

This application is based upon and claims the benefit of priority from Japanese Patent Application No. 2015-062055, filed on Mar. 25, 2015, the disclosure of which is incorporated herein in its entirety by reference.

### TECHNICAL FIELD

The present invention relates to a technology of presenting a product that a user is likely to purchase on a web site browsed by the user.

### BACKGROUND ART

On many electronic commerce (EC) sites, a recommended product is introduced to a registered member of the site. Specifically, a product already purchased and a product already browsed are extracted from information including a purchase history and a browsing history of the member. Then, a product having a similar function and shape to the extracted product or the like is selected and presented in the portal site and the like browsed by the member as a recommended product for the member. At the time of presentation, the product is presented in a conspicuous area in the site, such as an upper part, to attract the member's attention. Furthermore, the presentation area is linked to a URL for the recommended product described above, and the member can move to a purchase page for the recommended product simply by tapping or single-clicking the presentation area, or the like. Thus, the member can readily purchase the recommended product.

As a recommendation method, a content-based method, a collaborative filtering method, or a rule-based method is heavily used.

The content-based method creates content information including a detailed product description, a price, a product category, and the like for each product, and a similarity value between similar products is pre-calculated from each piece of the created content information. Subsequently, when a user purchases or browses a product, a product with a higher similarity value with respect to the product is preferentially recommended to the user, in other words, presented on a web page browsed by a member.

The collaborative filtering method sets a recommended product assuming that users having similar preference take similar actions (purchasing). Specifically, web access histories and purchase histories of a plurality of users are analyzed and a similarity value of preference between the users is pre-calculated based on the analysis result. When a user attempts to take an action such as purchasing a product, an action taken by another user having a high preference similarity value for the user is recommended. For example, at the time of product purchase, a comment such as “Customer who bought this book also bought a following book.” is displayed and another recommended product is presented together.

The rule-based method recommends a product, in accordance with a predetermined rule. The rule includes, for example, recommending a product of a company B to a person having purchased or browsed a product of a company A.

PTL 1 (Japanese Patent Application No. 2005-284421) discloses a technology of selecting a recommended product and recommending the product to a user, in accordance with subjective information indicating subjective evaluation on a product by a user such as a comment after product purchase.

The technologies based on the aforementioned three recommendation methods and PTL 1 recommend a recommended product, in accordance with subjective information of a user. However, the technologies and PTL 1 are not able to allow an information processing apparatus to, at the time of selecting a recommended product, make the selection reflecting an image and content of a description of the recommended product.

### SUMMARY

The present invention is made to solve the problem described above. A main object of the present invention is to provide an information processing apparatus and the like capable of presenting a recommended product meeting user preference, in accordance with product information including a product image and content of a product description.

An aspect of the present invention is: an information processing apparatus comprising:
a memory storing instructions; and
at least one processor configured to process the instructions to:
   perform pre-processing of transforming product data including a product image and a product description into a feature value;
   perform, as learning, machine learning on a feature value of user data indicating an attribute of a user purchasing a product and the feature value of the product data, and creating a model that learned a correlation between the feature value of the user data and the feature value of the product data; and
   acquire the feature data of the user data corresponding to a user accessing a site where products are being sold and the feature values of the product data of the products, calculate relevance scores by performing machine learning to which the model is applied, and determine a recommendation ranking of the products based on the relevance scores.

Another aspect of the present invention is: an information processing method comprising:
transforming product data including a product image and a product description into a feature value;
performing machine learning on a feature value of user data indicating an attribute of a user purchasing a product and the feature value of the product data, and creating a model that learned a correlation between the feature value of the user data and the feature value of the product data; and
acquiring feature data of the user data corresponding to a user accessing a site for purchase of the product and a feature value of the product data, performing machine learning applying the model to calculate a relevance score, and determining a recommendation ranking of the product, in accordance with the relevance score.

Another aspect of the present invention is: a non-transitory computer-readable recording medium recording a program for causing a computer to implement:
a function of transforming product data including a product image and a product description into a feature value;
a function of performing machine learning on a feature value of user data indicating an attribute of a user purchasing a product and the feature value of the product data, and creating a model that learned a correlation between the feature value of the user data and the feature value of the product data; and
a function of acquiring feature data of the user data corresponding to a user accessing a site for purchase of the product and a feature value of the product data, performing machine learning applying the model to calculate a relevance score, and determining a recommendation ranking of the product, in accordance with the relevance score.

The present invention is able to present a recommended product meeting user preference, in accordance with product information including a product image and content of a product description.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration example of an information processing apparatus according to a first exemplary embodiment of the present invention.

FIG. 2 is a diagram illustrating an example of a product introduction page in an EC site according to the first exemplary embodiment of the present invention.

FIG. 3 is a block diagram illustrating a configuration example of a pre-processing unit according to a second exemplary embodiment of the present invention.

FIG. 4 is a diagram illustrating an example of a data structure of a product data storage unit according to the second exemplary embodiment of the present invention.

FIG. 5 is a diagram illustrating an example of a data structure of a feature vector storage unit according to the second exemplary embodiment of the present invention.

FIG. 6 is a block diagram illustrating a configuration example of a learning unit according to the second exemplary embodiment of the present invention.

FIG. 7 is a diagram illustrating an example of a data structure of a purchase history storage unit according to the second exemplary embodiment of the present invention.

FIG. 8 is a diagram illustrating an example of a data structure of a browsing history storage unit according to the second exemplary embodiment of the present invention.

FIG. 9 is a diagram illustrating an example of a data structure of a member data storage unit according to the second exemplary embodiment of the present invention.

FIG. 10 is a block diagram illustrating a configuration example of a recommendation unit according to the second exemplary embodiment of the present invention.

FIG. 11 is a flowchart illustrating an operation example of the pre-processing unit according to the second exemplary embodiment of the present invention.

FIG. 12 is a flowchart illustrating an operation example of the learning unit according to the second exemplary embodiment of the present invention.

FIG. 13 is a diagram illustrating an example of a correct value table in a correct data temporary storage unit according to the second exemplary embodiment of the present invention.

FIG. 14 is a diagram illustrating an example of a learning data table in a learning data temporary storage unit according to the second exemplary embodiment of the present invention.

FIG. 15 is a diagram illustrating an example of a correct value table in the correct data temporary storage unit according to the second exemplary embodiment of the present invention.

FIG. 16 is a diagram illustrating an example of a learning data table in the learning data temporary storage unit according to the second exemplary embodiment of the present invention.

FIG. 17 is a flowchart illustrating an operation example of the recommendation unit according to the second exemplary embodiment of the present invention.

FIG. 18 is a diagram illustrating an example of a relevant data table in a relevant data temporary storage unit according to the second exemplary embodiment of the present invention.

FIG. 19 is a diagram illustrating an example of a relevance score table in a relevance score temporary storage unit according to the second exemplary embodiment of the present invention.

FIG. 20 is a block diagram illustrating an example of an internal configuration of a computer for implementing the first and second exemplary embodiments of the present invention.

### EXEMPLARY EMBODIMENT

Next, a detailed explanation will be given for exemplary embodiments with reference to the drawings. In the following description of the drawings, a same or like reference sign is given to a same or like part. The drawings schematically represent configurations according to the exemplary embodiments of the present invention. Furthermore, the exemplary embodiments of the present invention described below are examples and may be modified as appropriate as long as the nature of the present invention is not altered.

When purchasing a design-centric product (such as clothing, accessories, and furniture) at a web site such as an EC site, a user is not able to see or touch an actual product. Therefore the user decides on purchase relying solely on information that can be browsed on the web site. In the description of each exemplary embodiment of the present invention, there are three types of users. A first type is a user who purchased a product at an EC site in the past and registered personal information. A second type is a user making simplified registration (for example, registration of an e-mail address only) on an EC site and browsing the EC site. The first type user is hereinafter also referred to as a “member.” The “member” may include the second type user. A third type is an unregistered user browsing the EC site only.

At the time of browsing a product on a web site, what influences a user's purchase decision is a shape and coloring of a product itself photographed as a product image, appearance of the product image, and content of a description. Appearance of a product image refers to, for example, an angle at which the product is photographed, a state of light irradiation when the product is photographed, a situation in which a model is using the product to allow a user to readily image a specific use situation, and the like.

Popularity of a product image and a description varies with an age group, a gender, an occupation, and the like of a user browsing an EC site. For example, an elderly person has a tendency to prefer an image exhibiting a product in a large size and a short description in large letters. In contrast, a young person has a tendency to prefer an image including a plurality of smaller images exhibiting dressing examples, and a long description in small letters including a way of dressing and a comment by a purchaser assisting understanding of usefulness of the product. Further, a user preference tendency varies with a gender, a place of residence, and the like, in addition to an age group. Such a tendency may include, for example, a user having an attribute of “in the twenties, a female, a student, living alone, and resident in Tokyo metropolis” preferably purchases a product on an EC site page including an image of clothing in a pastel color and a description linked to a page carrying comments by others.

In order to reflect such a tendency for each user, each exemplary embodiment of the present invention performs machine learning on information obtained by adding feature data for each user to information composed of a combination of a product image and a description. Such feature data include a user's age, gender, occupation, and place of residence. Then, a learning model learning a correlation among each piece of information is created. Additionally, each exemplary embodiment of the present invention presents a recommended product on an EC site with a product image and a description fitting a user's feature by applying the created learning model to a layout of a page for browsing on the EC site.

The machine learning described above is supervised learning and, by analyzing information related to “a customer who purchased a product” in the past as training data, classifies the training data and discovers a rule (hereinafter described as “model”) for purchase of the product. Furthermore, a potential customer is discovered by use of the model.

Machine learning algorithms outputting a “relationship” among a product image, product description, and feature data for each user includes Supervised Semantic Indexing and its Extensions (SSI; NEC Laboratories America; Bing Bai, Jason Weston, Ronan Collobert, and David Grangier; Dec. 25, 2012). Furthermore, other machine learning algorithms including, for example, Support Vector Machine, Neural Net, and Bayes classifier may also be used.

### First Exemplary Embodiment

### Information Processing Apparatus

An information processing apparatus 100 according to a first exemplary embodiment of the present invention performs processing of displaying a recommended product for a user, in a web site browsed by the user through a computer and the like.

Processing according to the present exemplary embodiment is composed of three main phases. A first phase is a learning phase running a feature value of a product, such as a product image and a product description, and a feature value of a user, such as an age and a gender, through machine learning, and creating a model learning a correlation. A second phase is a recommendation phase calculating a relevance score from a machine learning engine applying the learning model described above with a feature value of a user browsing an EC site as an input, and determining a recommendation order (ranking). A third phase is a pre-processing phase transforming product data such as a product image and a product description into a feature value in advance as pre-processing of the learning phase and the recommendation phase. The feature-value-transformation processing of product data is processing required not only for the learning phase but also for the recommendation phase calculating a relevance score. Thus, the transformation processing from a feature value to a feature vector is performed in advance and the product data are stored in a storage unit as feature vector data to omit the feature-value-transformation processing of the product data in the recommendation phase.

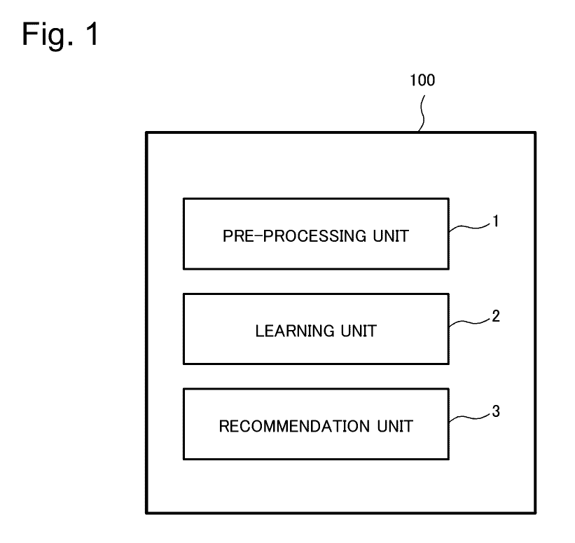

A configuration example of the information processing apparatus 100 according to the first exemplary embodiment of the present invention will be described with reference to FIG. 1. The information processing apparatus 100 includes a pre-processing unit 1, a learning unit 2, and a recommendation unit 3. The pre-processing unit 1 extracts a feature value of product data including a product image and a product description. The learning unit 2 performs machine learning on a feature value of data of a user purchasing a product and a feature value of product data, and creates a model learning a correlation between the feature value of user data and the feature value of product data. The recommendation unit acquires feature data of user data corresponding to a user accessing a site for purchase of a product and a feature value of product data. The recommendation unit further calculates a relevance score by performing machine learning applying the model, and determines a product recommendation order, in accordance with the relevance score.

With the configuration described above, the first exemplary embodiment of the present invention is able to present a recommended product meeting user preference, in accordance with product information including a product image and content of a product description.

### Second Exemplary Embodiment

Next, an information processing apparatus according to a second exemplary embodiment of the present invention will be described. The information processing apparatus according to the second exemplary embodiment includes a pre-processing unit 10 (corresponding to the pre-processing unit 1 in FIG. 1), a learning unit 20 (corresponding to the learning unit 2 in FIG. 1), and a recommendation unit 30 (corresponding to the recommendation unit 3 in FIG. 1).

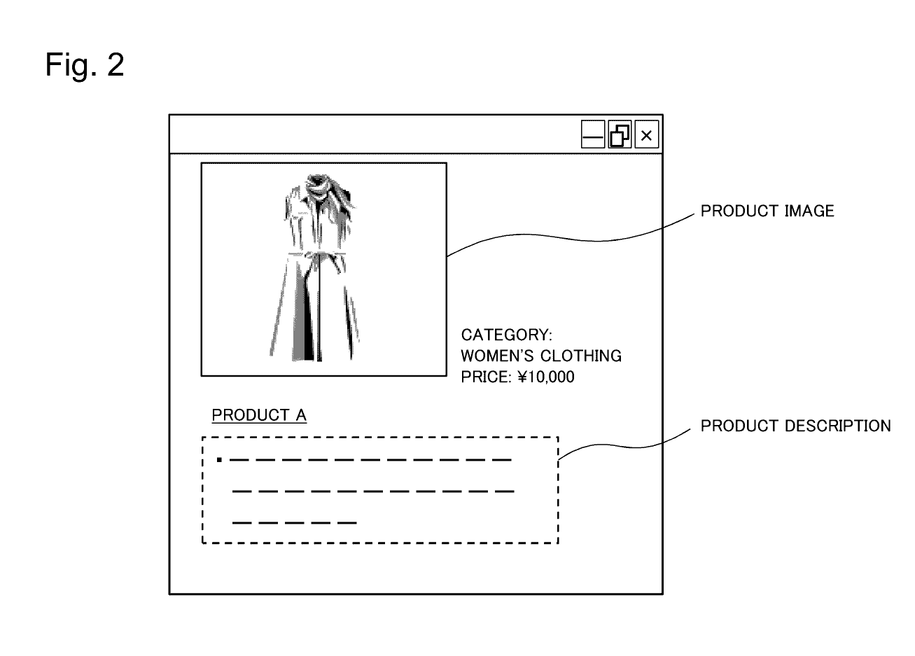

The pre-processing unit 10 acquires a product image and a product description (hereinafter described as “product data”) of each product purchased at an EC site, and transforms the acquired product data into each feature value. A product introduction page in an EC site is configured, for example, as illustrated in FIG. 2, and the page includes a product name, a price, and a category, in addition to product data (a product image and a product description).

The learning unit 20 acquires data indicating a product with a purchase record with respect to a member (hereinafter described as “correct data”) from a purchase history from the EC site and a browsing history of the EC site. The learning unit 20 performs machine learning with a feature value of the correct data, a feature value of data indicating the purchasing member, and a feature value of the product data transformed by the pre-processing unit 10 as input values. The learning unit 20 further creates a learning model learning a correlation.

The recommendation unit 30 calculates a relevance score (a numerical value indicating how well an input feature value fits a model [member]) from the learning model, with a feature value of attribute data of a member browsing the EC site, a feature value of attribute data of each product, and a feature value of product data as inputs. The recommendation unit 30 presents products as recommended products in descending order of the calculated value.

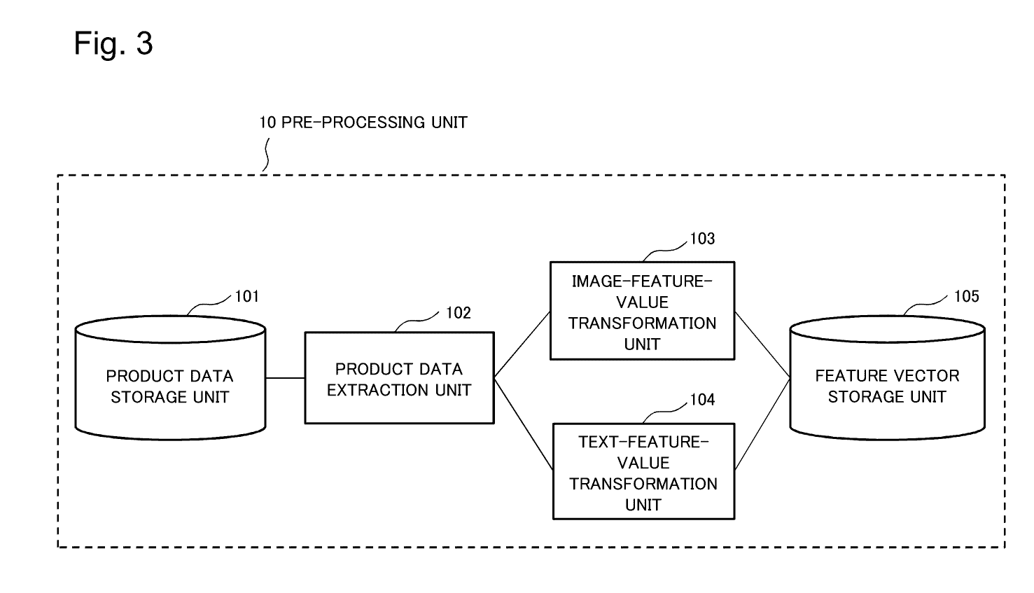

FIG. 3 is a diagram illustrating an internal configuration of the pre-processing unit 10. As illustrated in FIG. 3, the pre-processing unit 10 includes a product data storage unit 101, a product data extraction unit 102, an image-feature-value transformation unit 103, a text-feature-value transformation unit 104, and a feature vector storage unit 105.

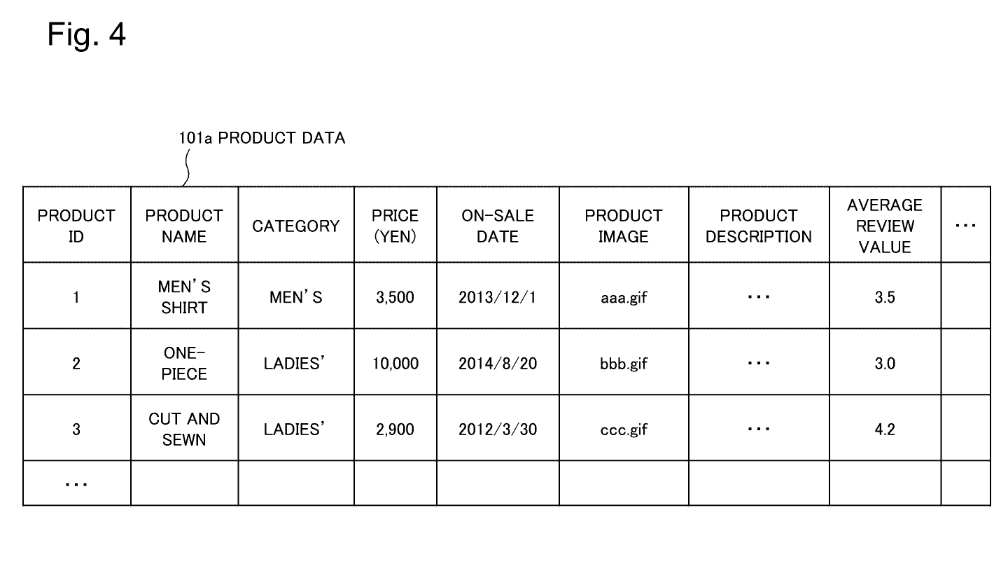

The product data storage unit 101 stores a product data 101a as illustrated in FIG. 4. Data items of the product data 101a include a “product ID,” a “product name,” a “category,” a “price,” an “on-sale date,” a “product image,” a “product description,” and an “average review value.” The product ID is an identifier for uniquely identifying a product. The category is a category a product belongs to. The average review value is an average value of evaluation values of the product by users purchasing the product.

The product data extraction unit 102 extracts an image and a product description of each product from the product data 101a as learning target data.

The image-feature-value transformation unit 103 transforms a feature value (for example, brightness and coloring) of the extracted image data into a vector sequence (numerical data sequence) by use of a Gabor filter (“Gabor Features and Support Vector Machine for Face Identification”, SHEN Linlin, Biomedical fuzzy and human sciences: the official journal of the Biomedical Fuzzy Systems Association 14(1), pp. 61-66, 2009-01-00). A Scale-Invariant Feature Transform (SIFT) method or a Histograms of Oriented Gradients (HOG) method (“Gradient-Based Feature Extraction—SIFT and HOG—,” Hironobu FUJIYOSHI, Information Processing Society of Japan, Research Report CVIM 160, pp. 211-224, 2007) may be used as another method of transforming image data into a numerical data sequence. The method may be designed to select an appropriate feature value transforming filter depending on content of an image and an image type.

The text-feature-value transformation unit 104 transforms a feature value of each description into a feature vector. Specifically, the text-feature-value transformation unit 104 breaks extracted description data down into words (feature values) by use of morphological analysis, and counts appearance frequency of each word. Additionally, the text-feature-value transformation unit 104 determines each word being a feature value to be a vector item and determines appearance frequency of each word to be a vector value. The text-feature-value transformation unit 104 further generates a vector sequence on the basis of the vector item and the vector value, and determines the generated vector sequence to be a feature vector. This feature value transformation case is an example. The text-feature-value transformation unit 104 may transform a feature value into a numerical data sequence composed of 1s and 0s, conforming to, for example, a rule that a word is determined to be a vector item, and a flag is set to 1 when the word is included in a text and 0 when not included. In feature value transformation, particles appear with high frequency in all product descriptions but are not necessary for analysis. Consequently, a good way to exclude unnecessary words also needs to be devised.

A vector sequence having unstructured data such as an image and a description as a feature value may become data with a very large vector length, and may be difficult to be applied to learning and prediction described later. Consequently, the text-feature-value transformation unit 104 is configured to select only a main feature value as a vector item out of a plurality of feature values, and generates a vector sequence including the selected vector item being compressed. The present exemplary embodiment uses, for example, a method described in Literatures 1 and 2 below as a generation method of a feature vector.

Literature 1: Sentiment Classification with Supervised Sequence Embedding, Bespalov, Dmitriy and Qi, Yanjun and Bai, Bing and Shokoufandeh, Ali

Literature 2: Machine Learning and Knowledge Discovery in Databases, Vol. 7523, pp. 159-174, Springer Berlin Heidelberg, 2012, ISBN: 978-3-642-33459-7

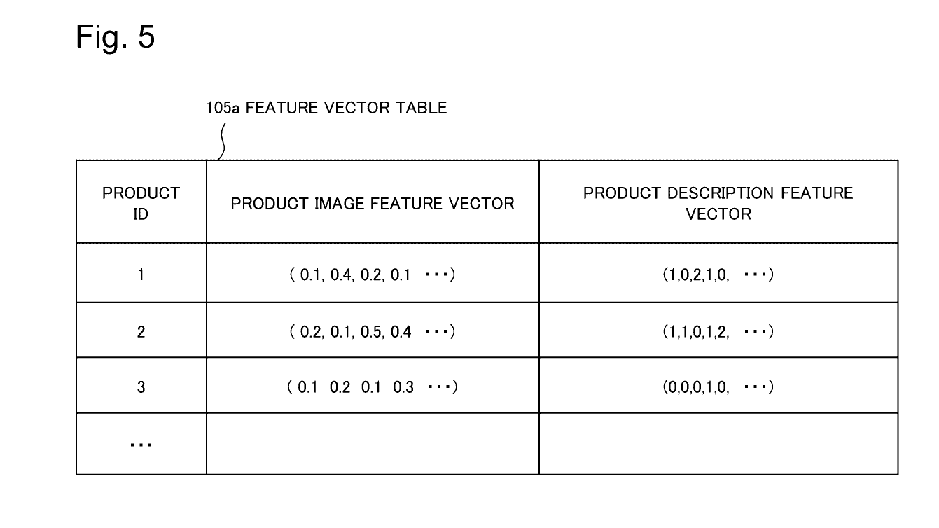

The feature vector storage unit 105 stores a transformed feature vector of a product image and a transformed feature vector of a product description into a feature vector table 105a as illustrated in FIG. 5 as numerical data for each product ID.

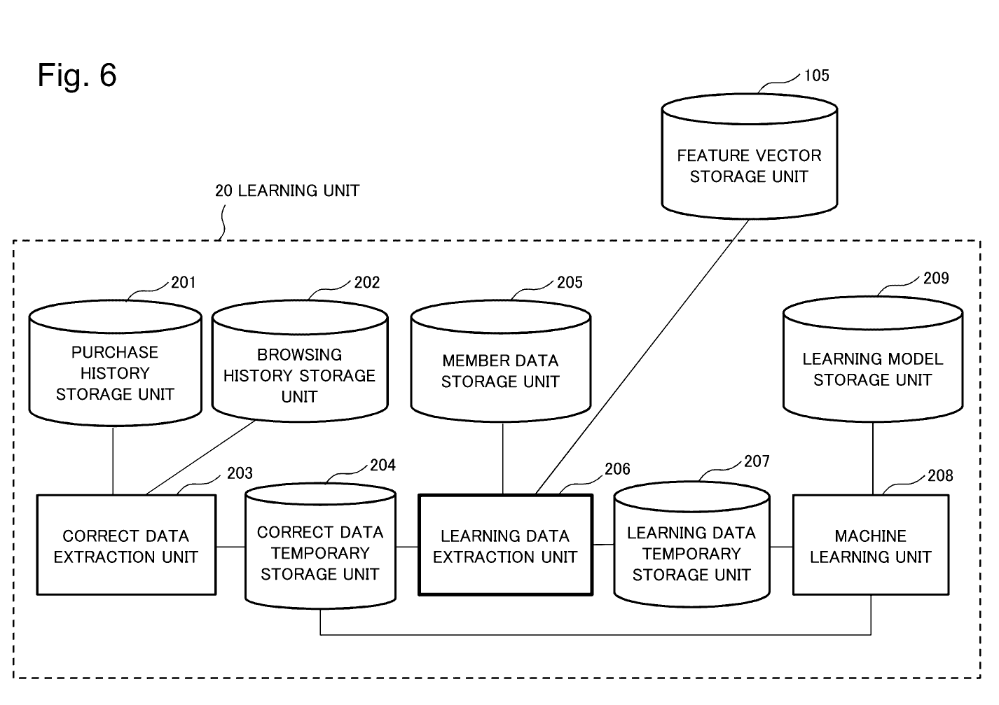

FIG. 6 is a diagram illustrating an internal configuration of the learning unit 20. As illustrated in FIG. 6, the learning unit 20 includes a purchase history storage unit 201, a browsing history storage unit 202, a correct data extraction unit 203, a correct data temporary storage unit 204, a member data storage unit 205, a learning data extraction unit 206, a learning data temporary storage unit 207, a machine learning unit 208, and a learning model storage unit 209.

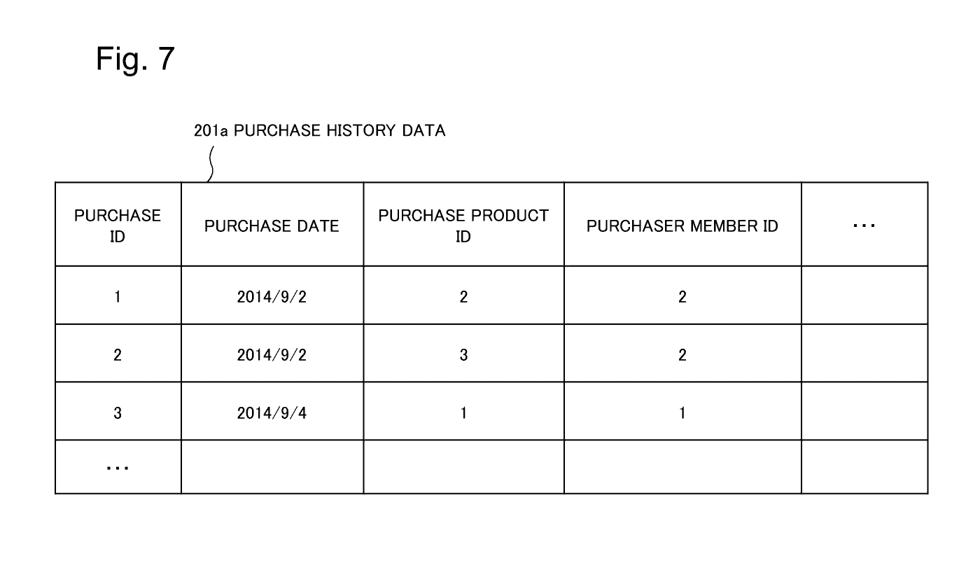

The purchase history storage unit 201 stores purchase history data 201a being a history of purchase of a product in an EC site by a member. As illustrated in FIG. 7, the purchase history data 201a include a “purchase ID,” a “purchase date,” a “purchase product ID,” and a “purchaser member ID” as data items. The purchase ID is an identifier allowing for uniquely specifying a single product purchase and may be expressed as a consecutive number in order of purchase date, or the like. The purchase product ID is a product ID of a purchased product. The purchaser member ID is an identifier (member ID) allowing for uniquely specifying a member making purchase. Details of the member ID will be described later. It is assumed that the purchase history data 201a in the purchase history storage unit 201 are set to accumulate automatically every time a member purchases a product.

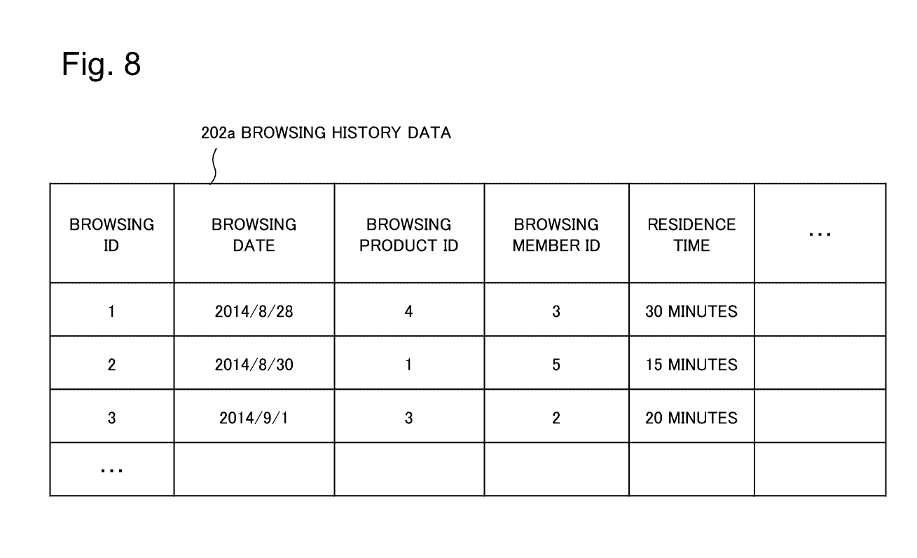

The browsing history storage unit 202 stores browsing history data 202a being a history of browsing of a product in an EC site by a member. As illustrated in FIG. 8, the browsing history data 202a include a “browsing ID,” a “browsing date,” a “browsing product ID,” a “browsing member ID,” and a “residence time” as data items. The browsing ID is an identifier allowing for uniquely specifying a single event of product browsing and may be expressed as a consecutive number in order of browsing date or the like. The browsing product ID is a product ID of a browsed product. The browsing member ID is an identifier (member ID) allowing for uniquely specifying a browsing member. Details of the member ID will be described later. The residence time is a time spent by a member for browsing a page carrying a product (target product). It is assumed that the browsing history data 202a in the browsing history storage unit 202 are set to accumulate automatically every time a member browses a product.

The correct data extraction unit 203 extracts purchase history data 201a for each member from the purchase history storage unit 201. Furthermore, the correct data extraction unit 203 determines a combination of a purchaser member ID and a purchase product ID in the purchase history data 201a, extracted for each member, to be a correct value (a combination value of data to be a learning target of a learning model). Data of a correct value (correct value data) may include a browsing history of a page (page view count) related to a product (target product) and actions taken by many and unspecified users on the page for the target product, in addition to a purchase record. The action includes, for example, “residence times” spent by many and unspecified users for browsing the page, a “click count” on the page, a “review score” related to the target product, a “favorite registration rate,” and a “number of inquiries.”

Alternatively, when a browsing history of a page related to the target product is determined to be a correct value, or included in correct value data, the correct data extraction unit 203 extracts the browsing history data 202a from the browsing history storage unit 202.

The correct data temporary storage unit 204 temporarily stores correct data extracted by the correct data extraction unit 203.

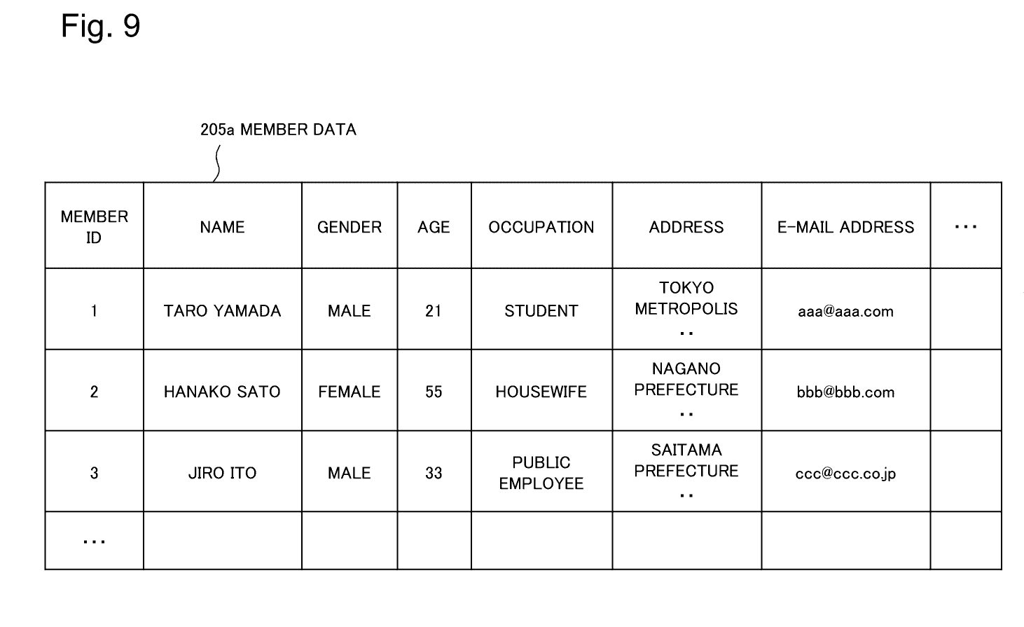

The member data storage unit 205 stores member data 205a being personal information of a member registered in an EC site. As illustrated in FIG. 9, the member data 205a includes a “member ID,” a “name,” a “gender,” an “age,” an “occupation,” an “address,” and an “e-mail address” as data items. The member may include a user making simplified registration. In this case, simplified personal information such as a temporary member ID and an e-mail address is to be registered. Member data of a simplified registration member may be stored in a database different from the member data storage unit 205.

The learning data extraction unit 206 takes extracted correct data (a member ID of a purchaser and a purchased product ID) from the correct data temporary storage unit 204. The learning data extraction unit 206 acquires member data 205a of a member from the member data storage unit 205 on the basis of the member ID and further acquires feature vector data corresponding to a product ID of a target product (a feature vector associated with a product ID) from the feature vector table 105a in the feature vector storage unit 105 on the basis of the product ID. The learning data extraction unit 206 stores the acquired feature vector data into the learning data temporary storage unit 207.

The learning data extraction unit 206 is set in such a manner that, out of member data 205a associated with a member ID, non-numerical data such as a gender and an occupation are expressed in numerical values. For example, gender data are denoted as “0: male” and “1: female.” Occupation data are denoted as “0: student,” “1: housewife,” and “2: company employee.” Age data are preferably quantified for each age group for ease of reflecting a tendency for each age group in a learning model. For example, age data are denoted as “0: 19 years old or younger,” “1: 20 to 29 years old,” and “2: 30 to 39 years old.” The learning data extraction unit 206 stores the quantified member data 205a into the learning data temporary storage unit 207 as a feature value of the member (a feature value associated with the member ID).

The learning data temporary storage unit 207 temporarily stores a feature vector associated with a product ID and a feature value associated with a member ID.

The machine learning unit 208 performs machine learning with a feature vector associated with a product ID and a feature value associated with a member ID temporarily stored in the learning data temporary storage unit 207, respectively, as well as a correct value temporarily stored in the correct data temporary storage unit 204, as input values. The machine learning unit 208 further creates a learning model learning a correlation. The machine learning unit 208 stores the created learning model into the learning model storage unit 209.

The learning model storage unit 209 stores a created learning model.

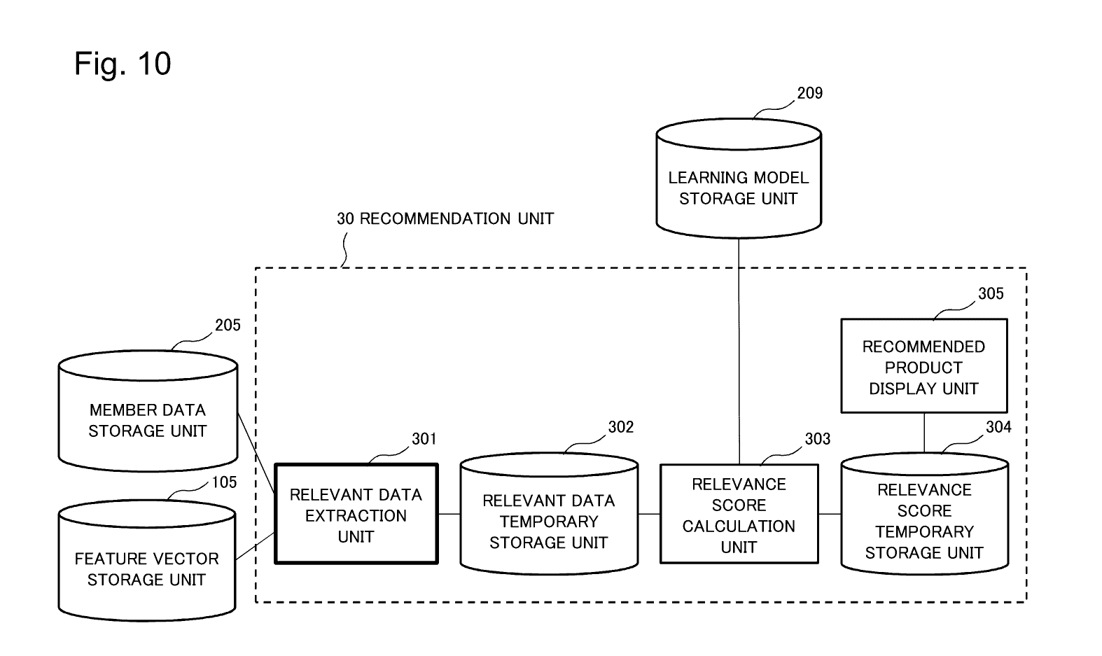

FIG. 10 is a diagram illustrating an internal configuration of the recommendation unit 30. As illustrated in FIG. 10, the recommendation unit 30 includes a relevant data extraction unit 301, a relevant data temporary storage unit 302, a relevance score calculation unit 303, a relevance score temporary storage unit 304, and a recommended product display unit 305.

When a member accesses an EC site for browsing, the relevant data extraction unit 301 acquires member data of the member from the member data storage unit 205 by use of a method of identifying a browsing person. The method of identifying a browsing person includes a method of requesting a member to input a login ID before browsing to identify the member with the login ID. A method of integrating EC site servers by forming an ad network to grasp which web site is visited by a browsing person from an access history of the EC site server is also included. Additionally, a method of specifying a visitor by issuing an ID for identifying a browsing person by use of a Hypertext Transfer Protocol (HTTP) cookie is included.

Furthermore, the relevant data extraction unit 301 acquires feature vector data associated with all products, respectively, from the feature vector table 105a in the feature vector storage unit 105. When a total quantity of the products is enormous, the data may be limited to data of a product in a specific category to be recommended to the member.

The relevant data temporary storage unit 302 temporarily stores member data and feature vector data acquired by the relevant data extraction unit 301.

The relevance score calculation unit 303 acquires a learning model from the learning model storage unit 209. The relevance score calculation unit 303 further calculates a relevance score with member data and feature vector data stored in the relevant data temporary storage unit 302 as input values, with a machine learning engine applying the acquired learning model.

The relevance score temporary storage unit 304 temporarily stores a relevance score of each product calculated by the relevance score calculation unit 303.

The recommended product display unit 305 presents several products with the highest relevance score values, out of relevance scores of respective products temporarily stored in the relevance score temporary storage unit 304, as recommended products for the member on a screen or the like browsed by the member.

Processing performed by the relevant data extraction unit 301 and the relevance score calculation unit 303 in the recommendation unit 30 may be directed to be performed by the pre-processing unit 10 when a member accesses an EC site. Alternatively, the pre-processing unit 10 may be directed to perform the processing in advance and the result may be directed to be stored in the relevance score temporary storage unit 304.

(Operations of Information Processing Apparatus)

Operations of the information processing apparatus according to the second exemplary embodiment of the present invention will be described. The operations of the information processing apparatus according to the second exemplary embodiment mainly include, an operation in the pre-processing unit 10, an operation in the learning unit 20, and an operation in the recommendation unit 30. These operations will be described in detail below.

(Operation by Pre-Processing Unit)

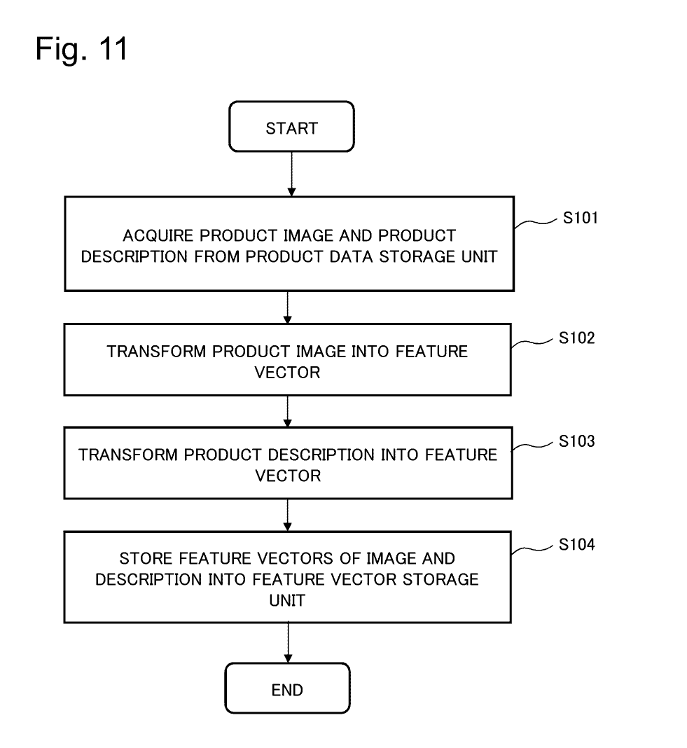

The operation in the pre-processing unit 10 (refer to FIG. 3) will be described with reference to a flowchart in FIG. 11.

First, in Step S101, the product data extraction unit 102 acquires a product image and a product description from the product data 101a in the product data storage unit 101.

In Step S102, the image-feature-value transformation unit 103 transforms a feature value of the acquired product image into a feature vector by use of a Gabor filter or the like. The feature value of an image to be used includes, for example, brightness of an entire image, and color distribution. The feature values xₙ (where n is a positive integer) are collectively expressed as a feature vector x by use of equation (1) below.

x=(x₁, x₂, . . . , x_{M})^{T} (1)

Note that x^{T} denotes a transposition of x. M denotes a quantity of feature values. Additionally, a boosting method may be used for feature value transformation.

In Step S103, the text-feature-value transformation unit 104 breaks the acquired description down into each word by morphological analysis, then counts appearance frequency of each word, and transforms each word (feature value) into a feature vector. In feature value transformation, each word is assumed to be an item of a vector representing a feature value, and appearance frequency is assumed to be a value of a vector. This feature value transformation case is an example and another quantifiable method may be used.

In Step S104, the image-feature-value transformation unit 103 stores a feature vector of a transformed product image into the feature vector table 105a in the feature vector storage unit 105 as data associated with the product ID. The text-feature-value transformation unit 104 stores the feature vector of the transformed product description into the feature vector table 105a in the feature vector storage unit 105 as data associated with the product ID. Consequently, the feature vector table 105a has a data structure as illustrated in FIG. 5.

(Operation by Learning Unit)

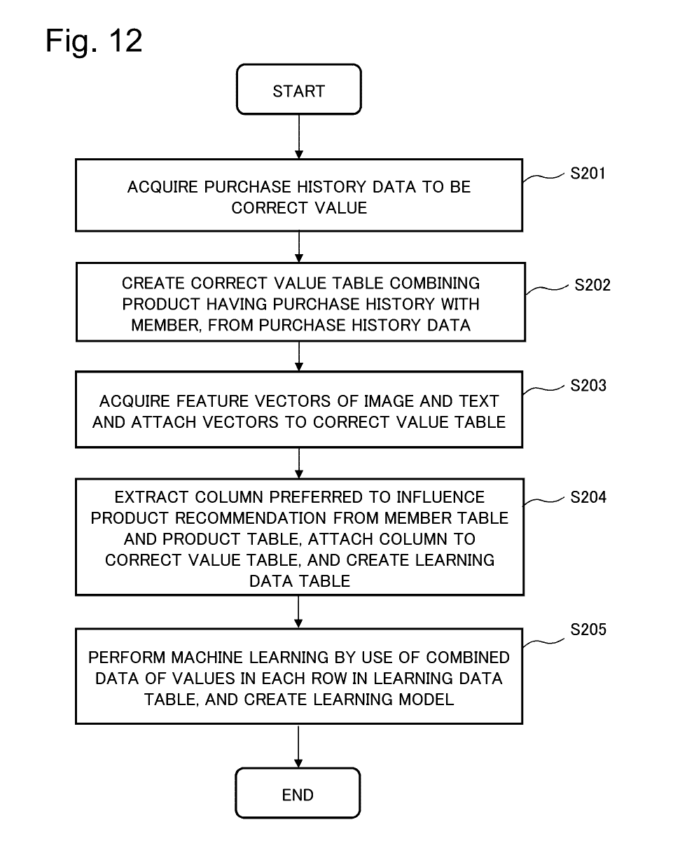

The operation in the learning unit 20 (refer to FIG. 6) will be described with reference to a flowchart in FIG. 12.

First, in Step S201, the correct data extraction unit 203 acquires purchase history data 201a used as a correct value from the purchase history storage unit 201. While data used as a correct value may include browsing history data 202a stored in the browsing history storage unit 202, purchase history data 201a are solely considered as data used as a correct value in the following description for ease of description.

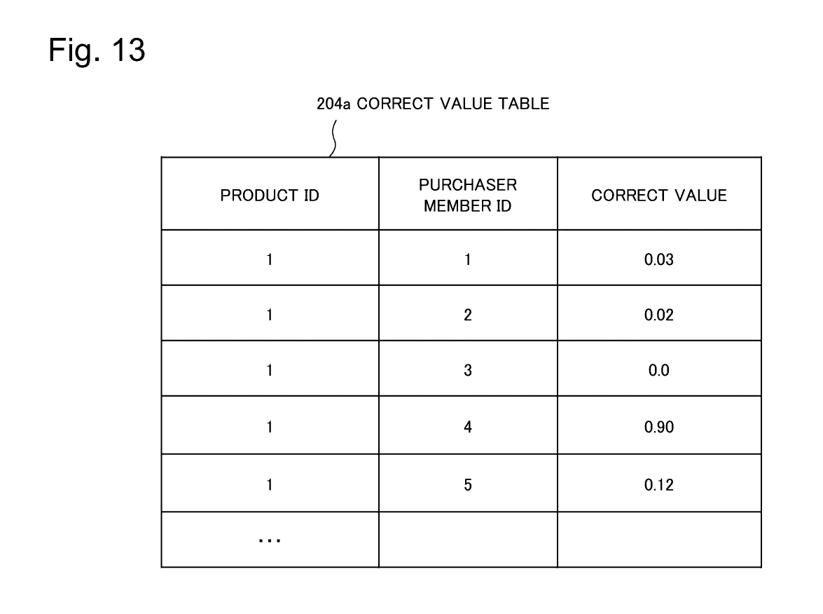

In Step S202, the correct data extraction unit 203 creates a correct value table 204a (refer to FIG. 13) combining a product having a purchase history with a member, in accordance with the purchase history data 201a stored in the purchase history storage unit 201. Specifically, the correct data extraction unit 203 acquires the purchase history data 201a from the purchase history storage unit 201. Subsequently, with the acquired purchase history data 201a, a combination of a product ID with a member ID of a member having a purchase record of a product associated with the product ID is set to a correct value “1.” Further, a combination with a product for which the member has no purchase record is set to a correct value “0.” Thus, the correct data extraction unit 203 creates a correct value table illustrated in FIG. 13, and causes the correct data temporary storage unit 204 to store the correct value table.

In Step S203, the learning data extraction unit 206 acquires the correct value table 204a from the correct data temporary storage unit 204. Furthermore, the learning data extraction unit 206 acquires a feature vector of an image and a feature vector of a text from the feature vector table 105a in the feature vector storage unit 105, and attaches both of the acquired vectors to the correct value table 204a.

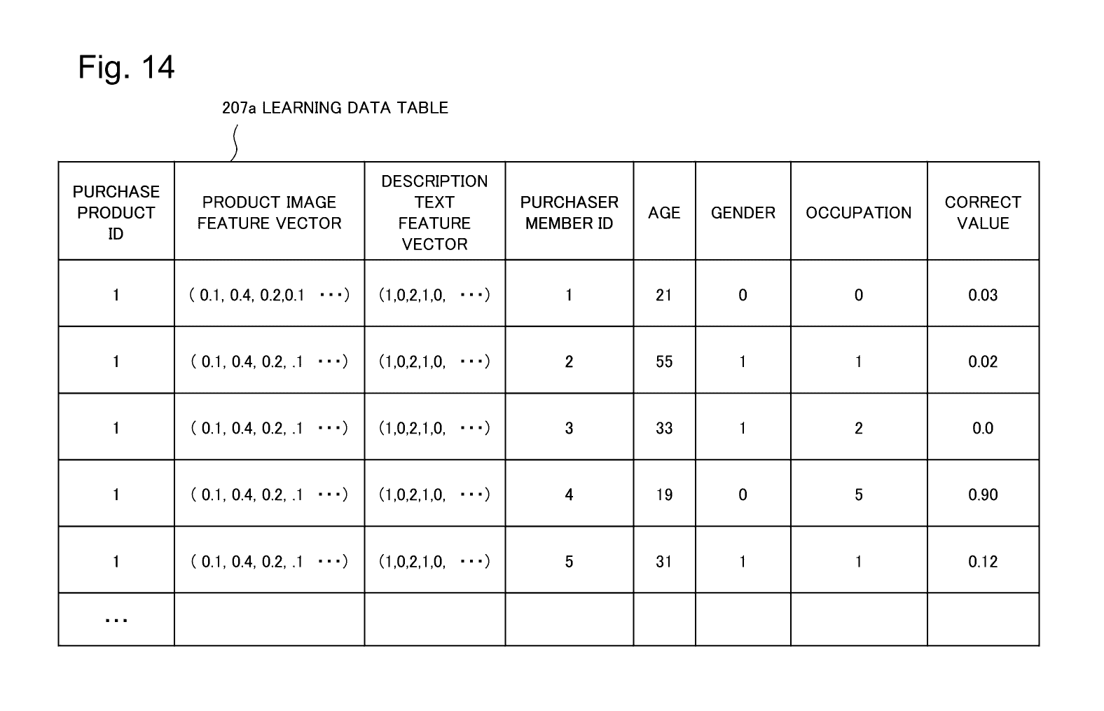

In Step S204, the learning data extraction unit 206 extracts a column of a user attribute (an item such as an age, a gender, and an occupation) preferred to influence selection of a recommended product from the member data 205a in the member data storage unit 205. Then, the learning data extraction unit 206 attaches the extracted user attribute to the correct value table 204a. The learning data extraction unit 206 creates a learning data table 207a illustrated in FIG. 14 from the correct value table 204a through these attachment processes. The learning data extraction unit 206 stores the created learning data table 207a into the learning data temporary storage unit 207.

In Step S205, the machine learning unit 208 acquires the learning data table 207a from the learning data temporary storage unit 207. The machine learning unit 208 performs machine learning with a combination of data in each column included in each row in the acquired learning data table 207a as an input value, and generates a learning model learning a correlation. The machine learning unit 208 stores the generated learning model into the learning model storage unit 209.

Modified examples of Steps S202 to S204 will be described.

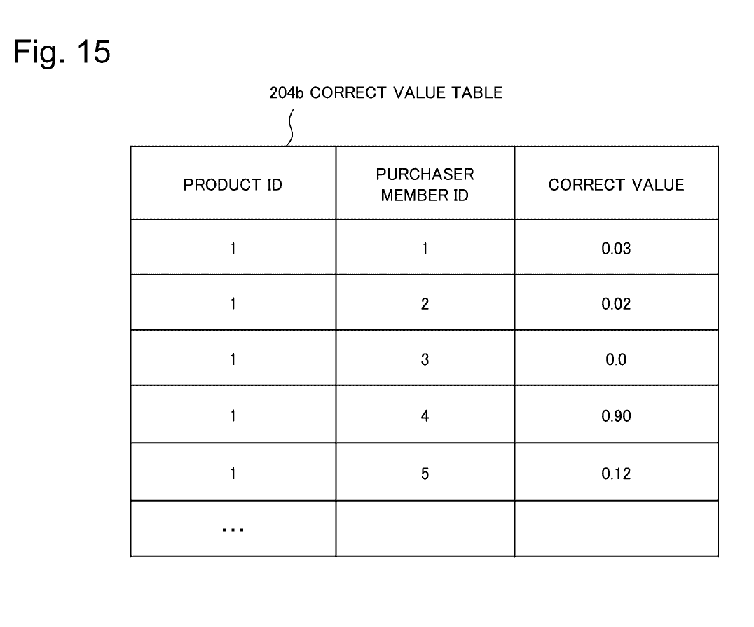

In a modified example of Step S202, the correct data extraction unit 203 may allow a correct value to be set to, for example, a numerical value with a decimal point between 0 and 1, in addition to the two values of “0” and “1.” For example, when a browsing count of a product page (page view count) is preferred to be a correct value, the correct data extraction unit 203 generates a normalized value of a browsing count of a product page by a user as a correct value. Normalization refers to, for example, transformation into a value in a range from 0 to 1 by dividing by a browsing count of the product page by all users. In this case, a correct value table 204b based on a browsing count (page view count) of a product page is as illustrated in FIG. 15.

As another example, when a value of “(number of purchase)÷(page view count)” is assumed to be a correct value, a feature of a product whose product page is not often browsed but purchased when the page is browsed, can be reflected in a recommendation order. Further, when a purchase season is preferred to be reflected in a recommendation tendency, the correct data extraction unit 203 may generate a purchase history around fall (from September to November) as a correct value to be able to recommend a product frequently purchased around fall. Thus, the correct data extraction unit 203 is capable of changing behavior of a product recommendation order (ranking) by changing content of a correct value.

As a modified example of Steps S203 and S204, the learning data extraction unit 206 may extract a column preferred to influence product recommendation from an item other than a product image and a product introduction sentence stored in the product data storage unit 101. Then the learning data extraction unit 206 may attach the column to a correct value table. A column preferred to influence product recommendation refers to, for example, a price, a category, a review score, and the browsing history data 202a stored in the browsing history storage unit 202.

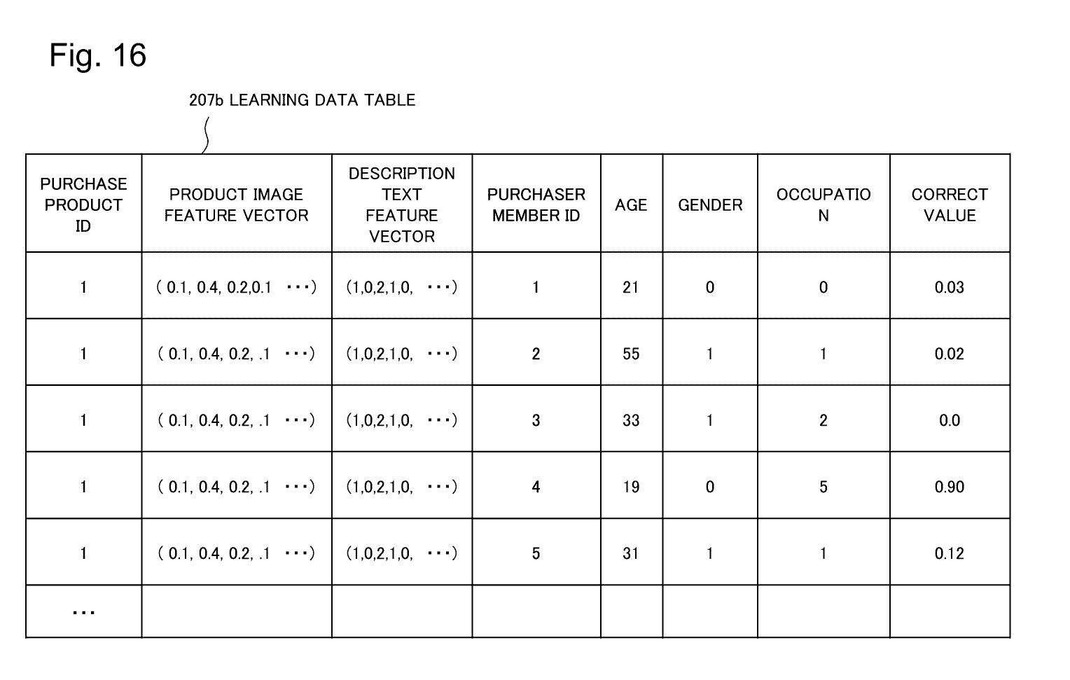

A learning data table 207b illustrated in FIG. 16 is an example of a learning data table created by use of the correct value table 204b (refer to FIG. 15) including the browsing history data 202a in a correct value. Thus, the learning data extraction unit 206 is capable of changing attribute information preferred to influence a product recommendation order by sorting out an attribute (item) column in the member data 205a and the product data 101a.

(Operation by Recommendation Unit)

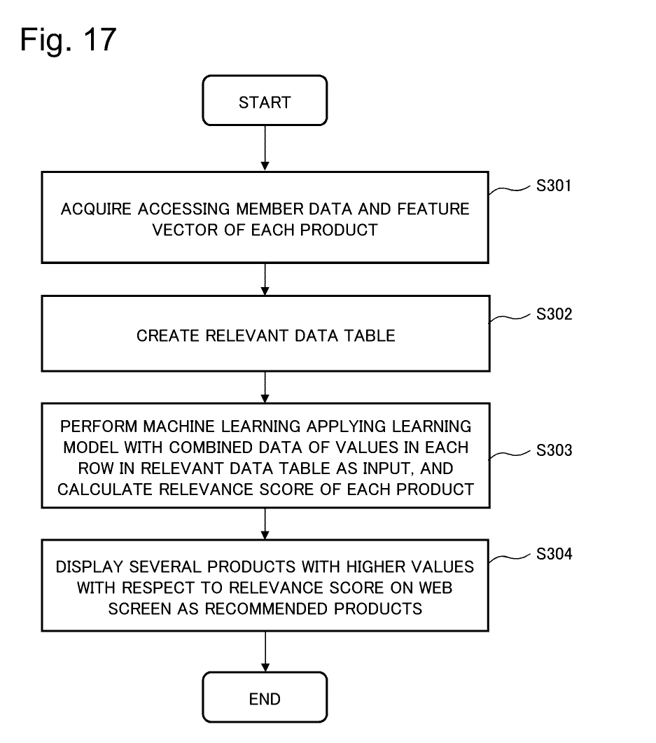

The operation in the recommendation unit 30 (refer to FIG. 10) will be described with reference to a flowchart in FIG. 17.

First, in Step S301, the relevant data extraction unit 301 acquires member data of a member accessing an EC site from the member data storage unit 205. A method of identifying a member accessing the EC site includes a method of requesting a member to enter a login ID prior to access and identifying the member by login ID. Additionally, the aforementioned browsing person identification method may be used. The relevant data extraction unit 301 further acquires feature vector data of each product image and feature vector data of each product description from the feature vector table 105a in the feature vector storage unit 105. When a product in a single category is to be introduced to a user, the relevant data extraction unit 301 may selectively acquire feature vector data of an image and a description related to a product in the category. Further, in a case that a processing time for calculating a relevance score is long when data for all products are acquired, due to performance of a processing server or the like, the relevant data extraction unit 301 may selectively acquire feature vector data of an image and a description related to a product in a specific category.

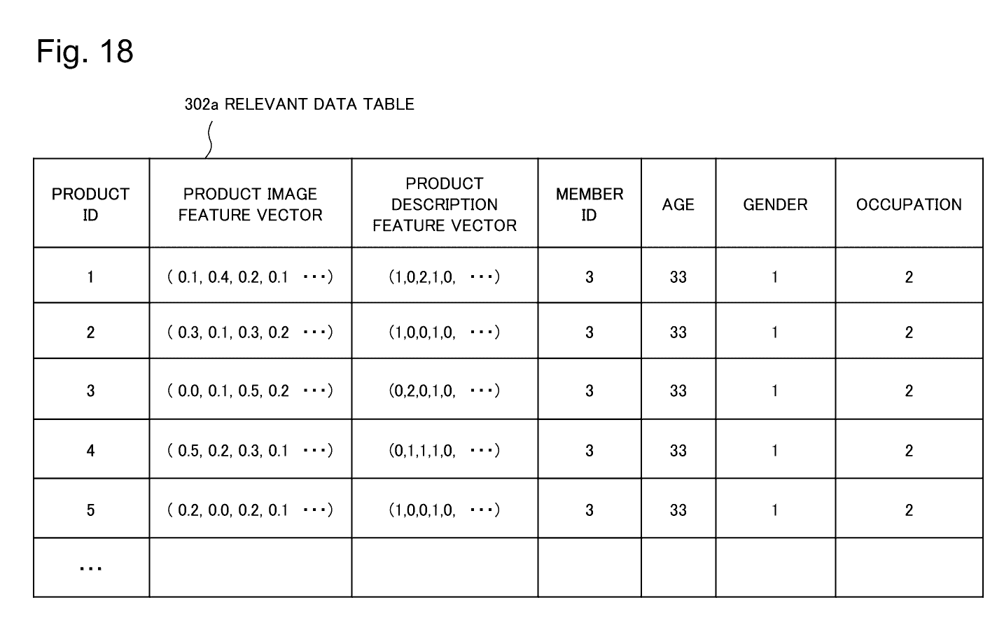

In Step S302, the relevant data extraction unit 301 combines attribute information of the acquired member data with feature vector data of each product image and feature vector data of each product description to create a relevant data table 302a (refer to FIG. 18). An attribute (item) set in each column in the relevant data table 302a is the same as the attribute set in the learning unit 20 at the time of learning (refer to FIG. 14). The relevant data extraction unit 301 stores the relevant data table 302a into the relevant data temporary storage unit 302.

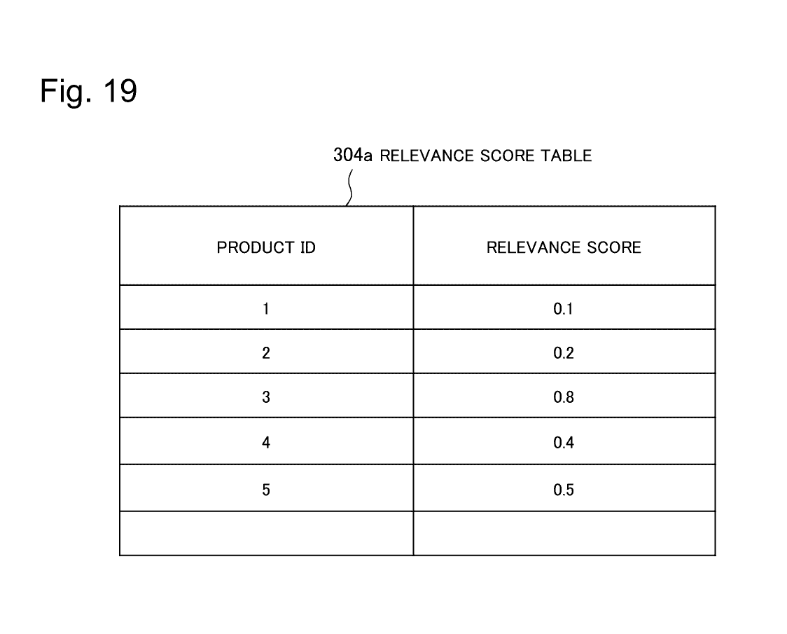

In Step S303, the relevance score calculation unit 303 acquires the relevant data table 302a from the relevant data temporary storage unit 302 and further acquires a learning model from the learning model storage unit 209. The relevance score calculation unit 303 performs machine learning applying the acquired learning model with a combination of data in each column included in each row in the acquired relevant data table 302a as an input value. Then, the relevance score calculation unit 303 calculates a relevance score table 304a (refer to FIG. 19) indicating a relevance score between each product and an accessing member. A relevance score is output as, for example, a value with a decimal point in a range from 0 to 1, and a relevance score closer to 1 indicates more relevance to the learning model. The relevance score calculation unit 303 stores the calculated relevance score table 304a into the relevance score temporary storage unit 304.

In Step S304, the recommended product display unit 305 displays products on a web screen in descending order of relevance score value (from a product with a relevance score closer to 1) as recommended products to the member, out of products in the relevance score table illustrated in FIG. 19. In the case of an example illustrated in FIG. 19, products associated with respective product IDs are displayed in an order of product ID 3, 5, 4, 2, and 1. The display is conducted when the member accesses the EC site.

### Modified Example of Second Exemplary Embodiment

When an attribute of product data (such as a product image and a product description) changes dynamically or frequently, the pre-processing unit 10 may transform a feature value of a product data attribute immediately before presenting a recommended product to a member, instead of transforming in advance. Dynamic or frequent change of an attribute of product data refers to, for example, a case that a product image is a video stream or the like, or a case that a product description includes product reviews by product purchasers and the reviews are frequently updated or added.

The feature vector table 105a in the feature vector storage unit 105 generated by the pre-processing unit 10 is used in the learning unit 20 and the recommendation unit 30. Thus, processing in the learning unit 20 and the recommendation unit 30 may be performed immediately after processing in the pre-processing unit 10. Alternatively, the learning unit 20 may use a pre-stored learning model generated by use of the feature vector storage unit 105 as is, and the recommendation unit 30 may cause the pre-processing unit 10 to generate the feature vector table 105a in the feature vector storage unit 105 once again immediately before presenting a recommended product to a member.

(Advantageous Effects of Second Exemplary Embodiment)

Advantageous effects of the second exemplary embodiment of the present invention will be described. The present exemplary embodiment is able to present a recommended product meeting user preference, in accordance with product information including a product image and content of a product description. The reason is that the pre-processing unit 10 transforms a product image and a product description into a feature vector, the learning unit 20 creates a learning model by use of the transformed feature vector, and the recommendation unit 30 determines a recommended product for a member by use of the created learning model.

Other effects will be described. A product image and a product introduction sentence are unstructured data. Accordingly, a user has product preference and a preferred way of presenting an image that are difficult to enter in a profile field when registering as a member of an EC site. However, the present exemplary embodiment is able to reflect unstructured data in a recommendation order. For example, preference such as “preference for an image of a top-and-bottom set of clothing” or “preference for a product presented with an enlarged photographic image of the product” instead of simple “preference for red clothing” may be reflected.

The present exemplary embodiment is able to make a recommendation comprehensively accommodating member preference including not only a product image and a product description but also other product information (such as a category, a price, and an average review value).

A preference tendency suiting a member attribute such as an age group, a gender, an occupation, a place of residence may be reflected in a recommendation order.

Information set to a correct value may be reflected in a recommendation order by causing a purchase record, a browsing count (page view count), a residence time, a click count, a favorite registration number, a review score, and the like to be the correct value or to be included in the correct value. Further, behavior of a recommendation order may be changed merely by changing a correct value. A plurality of correct values may be used in combination. For example, by setting (purchase quantity)÷(view count)=(correct value), a product whose product page is not often browsed but frequently purchased may be reflected in a recommendation order of recommended products.

(Hardware Apparatus)

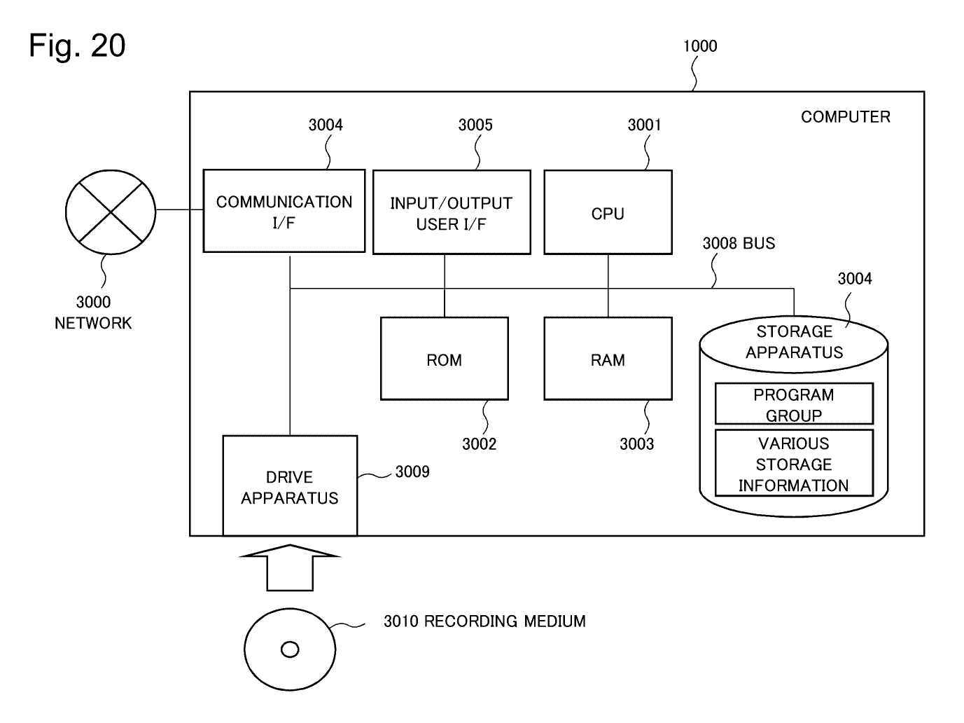

While the aforementioned information processing apparatus 100 can be implemented with an electronic circuit and the like, it can also be implemented by use of a computer. In this case, out of respective units illustrated in the pre-processing unit 10, the learning unit 20, and the recommendation unit 30 (FIGS. 3, 6, and 10) in the information processing apparatus 100 illustrated in FIG. 1, at least following units can be viewed as functional (processing) units of a software program or, in other words, software modules. The units include the product data extraction unit 102, the image-feature-value transformation unit 103, and the text-feature-value transformation unit 104 in FIG. 3, the correct data extraction unit 203, the learning data extraction unit 206, and the machine learning unit 208 in FIG. 6, and the relevant data extraction unit 301, the relevance score calculation unit 303, and the recommended product display unit 305 in FIG. 10. An example of a hardware environment capable of providing these functions (processing) will be described with reference to FIG. 20. Allocation of respective units in these drawings represents configurations illustrated for convenience of description, and various configurations can be assumed upon implementation.

A configuration example of a computer 1000 capable of implementing the information processing apparatus according to the first and second exemplary embodiments of the present invention will be described with reference to FIG. 20.

The computer 1000 illustrated in FIG. 20 is a general computer in which following components are interconnected through a bus (communication line) 3008.

Central processing unit (CPU) 3001

Read only memory (ROM) 3002

Random access memory (RAM) 3003

Storage apparatus 3004

Input/output user interface 3005

Communication interface 3006 for an external apparatus

Drive apparatus 3009

The drive apparatus 3009 reads software (a program) for executing the computer 1000 from a recording medium 3010.

Then, in the aforementioned hardware environment, the aforementioned exemplary embodiments are achieved through following procedures. That is, a computer program is provided to the computer 1000 illustrated in FIG. 20 from the drive apparatus 3009 or the storage apparatus 3004 storing a computer program group capable of providing a function of a block diagram (FIGS. 1, 3, 6, and 10) or a flowchart (FIGS. 11, 12, and 17) referenced in a description of a relevant exemplary embodiment. Subsequently, the computer program is read and interpreted by the CPU 3001 in the hardware and executed on the CPU 3001. Further, the computer program provided in the computer 1000 may be stored in a readable/writable volatile storage apparatus (RAM 3003) or a nonvolatile storage apparatus such as the storage apparatus 3004.

### INDUSTRIAL APPLICABILITY

The present invention may be used for determination of a product recommendation order on an EC site and the like. The present invention may also be used for selection of a product image, a product introduction sentence, and a combination of both preferred by a user (with a high product purchase rate), in accordance with the determination. For example, out of a plurality of product images photographed from various angles, an image (image group) providing a higher purchase rate may be selected. Additionally, out of a plurality of product descriptions described with various techniques, a description (description group) providing a higher purchase rate may be selected. Furthermore, a combination (combination group) of an image and a description providing the highest purchase rate may be selected.

The present invention may be used for evaluation of a photographed image and a profile text of a member on a Social Networking Site (SNS) and the like.

Further, the present invention may also be used for appropriateness evaluation of an image, a description, and a combination of both on a site introducing general information (for example, a dictionary site).

Furthermore, the present invention may also be used when selecting a combination of an image and a description providing a higher purchase rate and a click rate among images and descriptions appearing in an internet advertisement, an electronic flier and the like displayed on a web site.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

### REFERENCE SIGNS LIST

1 Pre-processing unit
2 Learning unit
3 Recommendation unit
10 Pre-processing unit
20 Learning unit
30 Recommendation unit
100 Information processing apparatus
101 Product data storage unit
101a Product data
102 Product data extraction unit
103 Image-feature-value transformation unit
104 Text-feature-value transformation unit
105 Feature vector storage unit
105a Feature vector table
201 Purchase history storage unit
201a Purchase history data
202 Browsing history storage unit
202a Browsing history data
203 Correct data extraction unit
204 Correct data temporary storage unit
204a Correct value table
204b Correct value table
205 Member data storage unit
205a Member data
206 Learning data extraction unit
207 Learning data temporary storage unit
207a Learning data table
207b Learning data table
208 Machine learning unit
209 Learning model storage unit
301 Relevant data extraction unit
302 Relevant data temporary storage unit
302a Relevant data table
303 Relevance score calculation unit
304 Relevance score temporary storage unit
304a Relevance score table
305 Recommended product display unit
1000 Computer
3001 CPU
3003 RAM
3004 Storage apparatus
3005 Input/output user interface
3006 Communication interface
3009 Drive apparatus
3010 Recording medium

We claim:

1. An information processing apparatus comprising:
a memory storing instructions; and
at least one processor configured to process the instructions to:
perform pre-processing of transforming product data including a product image and a product description into a feature value;
perform, as learning, machine learning on a feature value of user data indicating an attribute of a user purchasing a product and the feature value of the product data, and creating a model that learned a correlation between the feature value of the user data and the feature value of the product data; and
acquire the feature data of the user data corresponding to a user accessing a site where products are being sold and the feature values of the product data of the products, calculate relevance scores by performing machine learning to which the model is applied, and determine a recommendation ranking of the products based on the relevance scores.

2. The information processing apparatus according to claim 1, wherein,
in the pre-processing, the transformation of the product data into the feature value is performed on a plurality of pieces of the product data before creating the model in the learning.

3. The information processing apparatus according to claim 1, wherein
in the pre-processing, the transformation of the product data into the feature value is performed on a plurality of pieces of the product data when the user accesses a site for purchase of the product.

4. The information processing apparatus according to claim 1 wherein the processor further configured to store a purchase history of the product by the user in the memory, wherein
in the learning in accordance with information including a stored purchase history, a correct value table that combines the users and the products the users purchased is created.

5. The information processing apparatus according to claim 2 wherein the processor further configured to store a purchase history of the product by the user in the memory, wherein
in the learning in accordance with information including a stored purchase history, a correct value table that combines the users and the products the users purchased is created.

6. The information processing apparatus according to claim 3 wherein the processor further configured to store a purchase history of the product by the user in the memory, wherein
in the learning in accordance with information including a stored purchase history, a correct value table that combines the users and the products the users purchased is created.

7. The information processing apparatus according to claim 1 wherein the processor further configured to store an attribute of the user, wherein
in the learning, learning data is extracted in accordance with information including a stored attribute of the user and a created correct value table, and the model is created, in accordance with the learning data extracted.

8. The information processing apparatus according to claim 2 wherein the processor further configured to store an attribute of the user, wherein
in the learning, learning data is extracted in accordance with information including a stored attribute of the user and a created correct value table, and the model is created, in accordance with the learning data extracted.

9. The information processing apparatus according to claim 3 wherein the processor further configured to store an attribute of the user, wherein
in the learning, learning data is extracted in accordance with information including a stored attribute of the user and a created correct value table, and the model is created, in accordance with the learning data extracted.

10. The information processing apparatus according to claim 4 wherein the processor further configured to store an attribute of the user, wherein
in the learning, learning data is extracted in accordance with information including a stored attribute of the user and a created correct value table, and the model is created, in accordance with the learning data extracted.

11. An information processing method comprising:
transforming product data including a product image and a product description into a feature value;
performing machine learning on a feature value of user data indicating an attribute of a user purchasing a product and the feature value of the product data, and creating a model that learned a correlation between the feature value of the user data and the feature value of the product data; and
acquiring feature data of the user data corresponding to a user accessing a site for purchase of the product and a feature value of the product data, performing machine learning applying the model to calculate a relevance score, and determining a recommendation ranking of the product, in accordance with the relevance score.

12. The method according to claim 11, wherein,
in the transforming, the transformation of the product data into the feature value is performed on a plurality of pieces of the product data before creating the model in the learning.

13. The method according to claim 11, wherein
in the transforming, the transformation of the product data into the feature value is performed on a plurality of pieces of the product data when the user accesses a site for purchase of the product.

14. A non-transitory computer-readable recording medium recording a program for causing a computer to implement:
a function of transforming product data including a product image and a product description into a feature value;
a function of performing machine learning on a feature value of user data indicating an attribute of a user purchasing a product and the feature value of the product data, and creating a model that learned a correlation between the feature value of the user data and the feature value of the product data; and
a function of acquiring feature data of the user data corresponding to a user accessing a site for purchase of the product and a feature value of the product data, performing machine learning applying the model to calculate a relevance score, and determining a recommendation ranking of the product, in accordance with the relevance score.

15. The recording medium according to claim 14, wherein,
in the function of transforming, the transformation of the product data into the feature value is performed on a plurality of pieces of the product data before creating the model in the learning.

16. The recording medium according to claim 14, wherein
in the function of transforming, the transformation of the product data into the feature value is performed on a plurality of pieces of the product data when the user accesses a site for purchase of the product.

17. An information processing apparatus comprising:
pre-processing means for transforming product data including a product image and a product description into a feature value;
learning means for performing machine learning on a feature value of user data indicating an attribute of a user purchasing a product and the feature value of the product data, and creating a model that learned a correlation between the feature value of the user data and the feature value of the product data; and
recommendation means for acquiring feature data of the user data corresponding to a user accessing a site for purchase of the product and a feature value of the product data, performing machine learning applying the model to calculate a relevance score, and determining a recommendation ranking of the product, in accordance with the relevance score.

18. The apparatus according to claim 17, wherein,
in the transforming, the transformation of the product data into the feature value is performed on a plurality of pieces of the product data before creating the model in the learning.

19. The apparatus according to claim 17, wherein
in the transforming, the transformation of the product data into the feature value is performed on a plurality of pieces of the product data when the user accesses a site for purchase of the product.
